(19) United States
(12) Patent Application Publication
(10) Pub. No.: US 2026/0045850 A1
(43) Pub. Date: Feb. 12, 2026

(54) LINEAR MOTOR

(71) Applicant: SHENZHEN CRONUS TECHNOLOGY CO., LTD., Shenzhen (CN)

(72) Inventor: Guang YANG, Shenzhen (CN)

(21) Appl. No.: 19/359,800

(22) Filed: Oct. 16, 2025

Related U.S. Application Data
(63) Continuation of application No. PCT/CN2024/079696, filed on Mar. 1, 2024.

(51) Int. Cl. H02K 7/08; F16C 29/06; F16C 33/66; H02K 41/02

(52) U.S. Cl. CPC H02K 7/08; F16C 29/0697; F16C 33/66; H02K 41/02; F16C 2380/26

(57) ABSTRACT

The present invention relates to a linear motor, the rotor is well sealed through a sealing module when running on the stator slide rail, so that small external dust that affects the operating accuracy and stability performance of linear motor is not easy to enter the sealed space; the lubrication module communicates with the sealed space, so that the linear motor can be effectively lubricated during operation, further improving the operational accuracy and stability of the linear motor; the ball return end cap and the first chute together form a circulation loop for ball movement, the ball retaining plate fits with rotor through locating surface to improve the installation accuracy, meanwhile contact surfaces that limit balls are provided on both sides of the locating surface, so that a ball retaining plate can be used for two rows of circulation loops.

### TECHNICAL FIELD

The present invention relates to the technical field of stroke driving devices, particularly to a linear motor.

### BACKGROUND

Linear motor is a transmission device that directly converts electrical energy into linear motion mechanical energy without the need for any intermediate conversion mechanism, and can be seen as a rotating motor that is cut radially and flattened into a plane. Linear motor, also known as linear type electric motor, linear type motor, linear electric motor, and push rod motor, and the most commonly used types of linear motor include flat plate type, U-shaped groove type, and tube type.

Ball cage is a structure used in ball linear motors to keep the balls running in a predetermined track and maintaining smooth rolling. In order to maintain good stroke accuracy and stability performance, conventional ball linear motors often have at least two rows of rotating ball channels, and in order to maintain contact between the balls and the track, the number of ball cages generally match that of rotating ball channels. However, the ball cages themselves have certain processing accuracy and installation deviation. After multiple ball cages are installed, the greater impact on the linear motor will result in a decrease in the operating accuracy and stability performance of linear motor.

### SUMMARY

In order to solve the problem of decreased operating accuracy and stability performance of linear motors caused by multiple ball cages, the present invention proposes a linear motor.

The technical solution adopted by the present invention is that: a linear motor comprising a stator slide rail and a rotor that slidably fits on the stator slide rail, further comprising:
a sealing module that is disposed on the rotor and slidably seals with the stator slide rail, and the rotor, stator slide rail, and sealing module together enclose a sealed space;
a ball return end cap that is disposed at both ends of the rotor, and each ball return end cap has a ball-returning channel, and the ball-returning channel and the first chute together form a circulating loop for ball movement;
a lubrication module that is disposed in the linear motor and connected to the sealed space;
a ball retaining plate comprising a locating surface that fits with the rotor, and contact surfaces that limit balls are provided on both sides of the locating surface.

Preferably, the locating surface has a strip-shaped depression and/or strip-shaped protrusion along the sliding direction of the rotor, and the rotor has a fitting portion that is plug-in fitted with the strip-shaped depression and/or strip-shaped protrusion of the locating surface.

Preferably, the rotor and the ball retaining plate together form the first chute having a contact gap, the contact gap is provided along the sliding direction of the rotor, the ball is controlled within the first chute, and each ball partially extends out from the contact gap to contact the stator slide rail.

Preferably, the ball retaining plate is vertically symmetrical, and the contact gap is symmetrical along the plane of symmetry of the ball retaining plate.

Preferably, the contact gap located on the upper side of locating surface faces diagonally upward; the contact gap located on the lower side of locating surface faces diagonally downwards.

Preferably, the ball is close to the upper or lower half of one side of the stator slide rail and in contact with the stator slide rail.

Preferably, the ball-returning channel has a first return port and a second return port, and the ball return end cap is provided with an oil passage connected to the outside, and the oil passage communicates with the ball-returning channel.

Preferably, the ball-returning channel is provided with a groove structure that is inwardly recessed away from the ball-returning channel, and the groove structure is disposed along the direction of ball return path of the ball-returning channel.

Preferably, the sealing module comprises a first sealing unit, and the rotor is connected to the first sealing unit that maintains sealing contact with the stator slide rail, the first sealing unit extends towards both ends along the sliding direction of the rotor and is in contact with both ends of the rotor, and the rotor, the first sealing unit, and the stator slide rail together form a sealed space.

Preferably, the lubrication module comprises an oil box, an oil guide component, and a lubrication unit, and the linear motor is connected to the oil box having an oil storage chamber, and the oil storage chamber internally has an oil guide component, the oil guide component has a buffer surface and an oil guide end extending from the buffer surface towards the opposite side, and the oil guide component is connected to the lubrication unit that is used for linear motor lubrication.

Compared with the prior art, the present invention has the following beneficial effects:

The present invention discloses a linear motor comprising a stator slide rail and a rotor that slidably fits on the stator slide rail, further comprising: a sealing module that is disposed on the rotor and slidably seals with the stator slide rail, and the rotor, stator slide rail, and sealing module together enclose a sealed space; a ball return end cap that is disposed at both ends of the rotor, and each ball return end cap has a ball-returning channel, and the ball-returning channel and the first chute together form a circulating loop for ball movement; a lubrication module that is disposed in the linear motor and connected to the sealed space; a ball retaining plate comprising a locating surface that fits with the rotor, and contact surfaces that limit balls are provided on both sides of the locating surface. The rotor is well sealed through a sealing module when running on the stator slide rail, so that small external dust that affects the operating accuracy and stability performance of linear motor is not easy to enter the sealed space; the lubrication module communicates with the sealed space, so that the linear motor can be effectively lubricated during operation, further improving the operational accuracy and stability of the linear motor; the ball return end cap and the first chute together form a circulation loop for ball movement, the ball retaining plate cooperates with rotor through locating surface to improve the installation accuracy, meanwhile contact surfaces that limit balls are provided on both sides of the locating surface, so that a ball retaining plate can be used for two rows of circulation loops to avoid the addition of more ball retaining plates, improving the operating accuracy and stability of linear motor. Compared with prior art, the linear motor disclosed in the present application can improve the operating accuracy and stability performance of the linear motor.

### BRIEF DESCRIPTION OF THE DRAWINGS

The present invention will be described in detail with reference to the embodiments and accompanying drawings:

FIG. 1 is a structural diagram of a linear motor provided according to an embodiment of the present invention;

FIG. 2 is a structural diagram of the oil guide component in a linear motor provided according to FIG. 1;

FIG. 3 is a cross-sectional view of a linear motor provided according to FIG. 1;

FIG. 4 is a structural diagram of a rotor (with some structure removed) in a linear motor provided according to FIG. 1;

FIG. 5 is an enlarged view of area A in a linear motor provided according to FIG. 4;

FIG. 6 is a structural diagram of a rotor in a linear motor provided in FIG. 4, with oil guide component and lubrication unit removed;

FIG. 7 is a structural diagram of a rotor in a linear motor provided according to an embodiment of the present invention;

FIG. 8 is a structural diagram of a ball retaining plate in a linear motor provided according to FIG. 7;

FIG. 9 is a side view of a linear motor provided according to FIG. 7;

FIG. 10 is a structural diagram of a ball return end cap in a linear motor provided according to an embodiment of the present invention;

FIG. 11 is a structural diagram of a ball return end cap provided in FIG. 10 from the other direction;

FIG. 12 is a structural diagram of a ball return plate in a ball return end cap provided according to FIG. 10;

FIG. 13 is a structural diagram of a ball return plate of a ball return end cap provided in FIG. 12, from the other direction;

FIG. 14 is a structural diagram of the end cover plate of a ball return end cap provided according to FIG. 10;

FIG. 15 is a structural diagram of the stator in a linear motor provided according to an embodiment of the present invention;

FIG. 16 is a structural diagram of a linear motor (excluding the second sealing unit and partial structure on the left side) provided according to an embodiment of the present invention;

FIG. 17 is a right side view of a linear motor with a stator slide rail provided according to FIG. 16;

FIG. 18 is an enlarged view of area B in a linear motor provided according to FIG. 16;

FIG. 19 is an enlarged view of area C in a linear motor according to FIG. 17.

### DESCRIPTION OF REFERENCE NUMERALS

10. Stator slide rail; 11. Track; 12. Sliding surface;
20. Rotor; 21. Ball chute; 22. Contact gap; 23. Installation fit portion;
30. Sealing module; 31. First sealing unit; 311. Curved end; 312. slot; 313. Locating protrusion; 314. notch; 315. First sealing element; 316. Second sealing element; 32. Second sealing unit;
40. Lubrication module; 41. Oil box; 411. Oil storage chamber; 412. oiling chamber; 413. Oil guide component; 4131. Buffer surface; 4132. Oil guide end; 414. Barrier portion; 415. End seal; 416. Oil baffle; 417. Locating protrusion; 43. Lubrication unit; 431. First end; 432. Second end;
50. Ball retaining plate; 51. Contact surface; 52. Locating surface; 53. Strip-shaped protrusion; 54. Installation hole; 55. Second fit surface;
60. Ball return end cap; 601. End cap body; 602. End cover plate; 603. ball return plate; 604. Second limiting portion; 61. Ball-returning channel; 62. First return port; 63. Second return port; 64. Oil passage; 641. First oil inlet; 642. Second oil inlet; 643. Connecting port; 65. Groove structure; 66. Installation portion; 661. Gap; 662. First limiting portion.

### DETAILED DESCRIPTION OF THE EMBODIMENTS

To clarify the purpose, technical solution, and advantages of the present invention more clearly, the embodiments of the present invention will be further described in detail below in conjunction with the accompanying drawings. Examples of the embodiment are shown in the accompanying drawings, where identical or similar reference numerals, from beginning to end, represent identical or similar components, or the components with identical or similar functions. The embodiments described below with reference to the accompanying drawings are exemplary and are only used to explain the present invention, and cannot be construed as limiting the present invention.

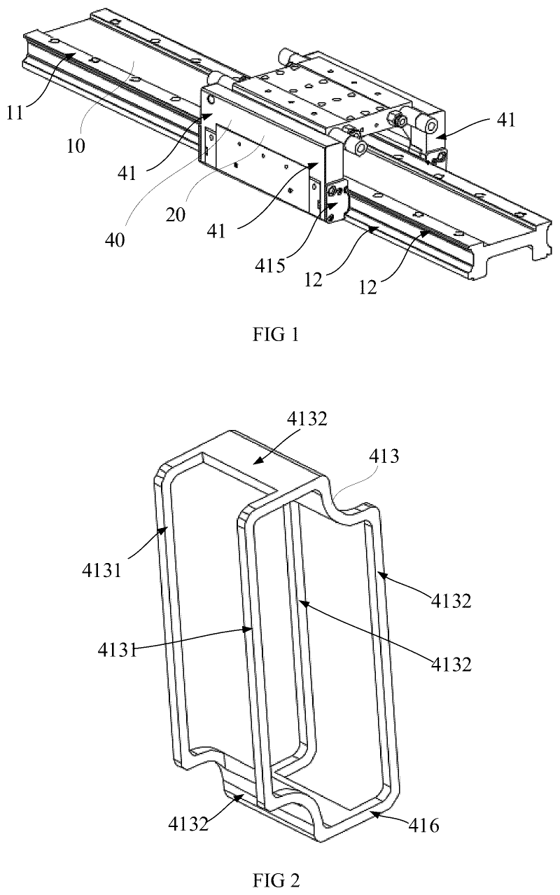

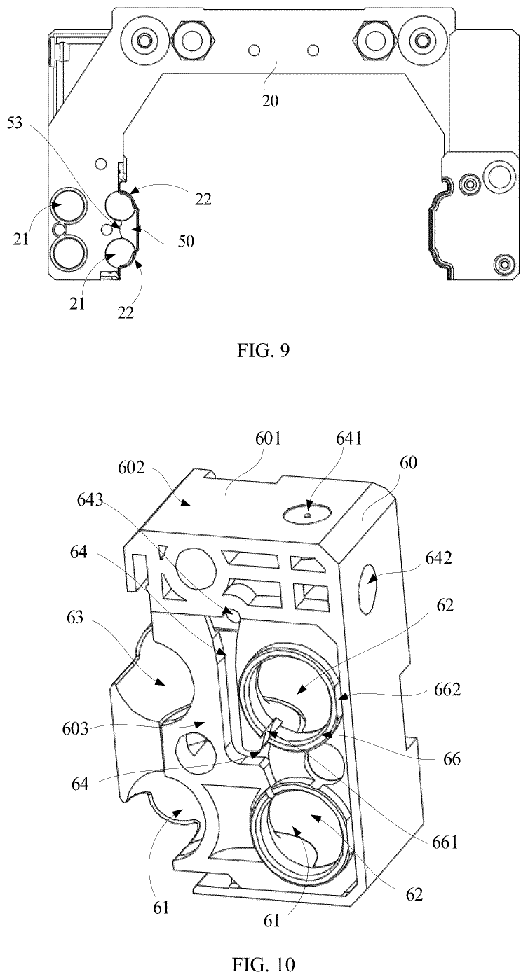

The present invention discloses a linear motor, as shown in FIG. 1, FIG. 7 to FIG. 9, comprising a stator slide rail 10 and a rotor 20 that slidably fits on the stator slide rail 10, further comprising:
a sealing module 30 that is disposed on the rotor 20 and slidably seals with the stator slide rail 10, and the rotor 20, stator slide rail 10, and sealing module 30 together enclose a sealed space;
a ball return end cap 60 that is disposed at both ends of the rotor 20, and each ball return end cap 60 has a ball-returning channel 61, and the ball-returning channel 61 and the first chute together form a circulating loop for ball movement;
a lubrication module 40 that is disposed in the linear motor and connected to the sealed space;
a ball retaining plate 50 comprising a locating surface 52 that fits with the rotor 20, and contact surfaces 51 that limit balls are provided on both sides of the locating surface 52.

The rotor 20 is well sealed through a sealing module 30 when running on the stator slide rail 10, so that small external dust that affects the operating accuracy and stability performance of linear motor is not easy to enter the sealed space; the lubrication module 40 communicates with the sealed space, so that the linear motor can be effectively lubricated during operation, further improving the operational accuracy and stability of the linear motor; the ball return end cap 60 and the first chute together form a circulation loop for ball movement, the ball retaining plate 50 cooperates with rotor 20 through locating surface 52 to improve the installation accuracy, meanwhile contact surfaces 51 that limit balls are provided on both sides of the locating surface 52, so that a ball retaining plate 50 can be used for two rows of circulation loops to avoid the addition of more ball retaining plates 50, improving the operating accuracy and stability of linear motor. Compared with prior art, the linear motor disclosed in the present application can improve the operating accuracy and stability performance of the linear motor.

It should be noted that the sealing module 30 isolates the rotor 20 from the external environment to prevent small dust or oil stains from entering the linear motor. The lubrication module 40 lubricates the rotor 20 or stator slide rail 10 with lubricating substances such as lubricating oil, thereby reducing friction between the two and improving operational accuracy and stability. The ball retaining plate 50 improves the operational accuracy and stability of the linear motor by changing its own structure and assembly form with the rotor 20. By optimizing the linear motor from different dimensions, the accuracy and stability of the linear motor are improved. After testing by engineering personnel, it not only produces a simple superposition effect, but also has better accuracy and stability performance.

The ball retaining plate 50 is a component in close contact with the ball bearings, so its installation accuracy will greatly affect the operating accuracy of the linear motor. Even a small deviation or tilt of the ball retaining plate 50 may have a significant impact on the friction coefficient between the ball bearings and the stator slide rail 10. Therefore, it is very important to improve the installation accuracy of the ball retaining plate 50. This application improves installation accuracy by setting a locating surface 52 on the ball retaining plate 50 that cooperates with the rotor 20. The shape of the locating surface 52 can be any shape that can match the locating of the ball retaining plate 50, ensuring good locating effect for the ball.

In addition, contact surfaces 51 are provided on both upper and lower sides of the locating surface 52 on the ball retaining plate 50, firstly, the ball retaining plate 50 can limit the ball on both sides, and it is unnecessary to provide a ball retaining plate 50 for each loop, in order to prevent reduced operating accuracy of linear motor due to the processing accuracy and installation deviation of excessive ball retaining plates; Secondly, the balls located on both sides of the ball retaining plate 50 provide support for the ball retaining plate 50, making it less prone to deformation or bending; Thirdly, the balls are located on both sides of the ball retaining plate 50, the ball retaining plate 50 is installed on the stator slide rail 10, they together provide a dual track locating, enabling better limiting effect on the rotor 20; when the rotor 20 vibrates, the balls at both ends will also vibrate slightly with the ball retaining plate 50. Due to the presence of balls at both ends of the ball retaining plate 50, the ball retaining plate 50 faces greater inertia for shake, and lower chance of vibration, thereby enhancing the stability and operational accuracy of the linear motor.

In some embodiments, as shown in FIG. 7 to FIG. 9, the locating surface 52 has a strip-shaped depression and/or strip-shaped protrusion 53 along the sliding direction of the rotor 20, and the rotor 20 has a fitting portion that is plug-in fitted with the strip-shaped depression and/or strip-shaped protrusion of the locating surface 52.

Specifically, the locating surface 52 has a strip-shaped depression and/or strip-shaped protrusion 53 along the sliding direction of the rotor 20, the strip-shaped depression and/or strip-shaped protrusion 53 is plug-in fitted with the fitting portion on the rotor 20, so that the strip-shaped depression and/or strip-shaped protrusion 53, compared with other shapes, has larger mutual fit areas, higher structural strength, while effectively preventing the ball retaining plate 50 from tilting or shifting, affecting the operational accuracy of the linear motor. It should be noted that the locating surface 52 may have both strip-shaped depressions and strip-shaped protrusions 53, in order to prevent incorrect direction when cooperating with the fit portion, and play a foolproof role.

In some embodiments, as shown in FIG. 7 to FIG. 9, the rotor 20 and the ball retaining plate 50 together form the first chute having a contact gap 22, the contact gap 22 is provided along the sliding direction of the rotor 20, the ball is controlled within the first chute, and each ball partially extends out from the contact gap 22 to contact the stator slide rail 10.

It should be noted that the rotor 20 and the ball retaining plate 50 together form the first chute having a contact gap 22, the contact gap 22 is provided along the sliding direction of the rotor 20, the ball can move in contact with the stator slide rail 10 through the contact gap 22, allowing the rotor 20 to operate on the stator slide rail 10. The ball retaining plate 50, as part of the first chute, makes it easier to assemble balls for the rotor 20, while also effectively reducing the volume of the rotor 20, miniaturizing the linear motor.

In some embodiments, as shown in FIG. 7 to FIG. 9, the ball retaining plate 50 is vertically symmetrical, and the contact gap 22 is symmetrical along the plane of symmetry of the ball retaining plate 50.

Specifically, the ball retaining plate 50 is symmetrical vertically, providing higher structural strength on the one hand, and on the other hand, there are no differences that may affect the operation accuracy of linear motor due to the asymmetry of the ball retaining plate 50 when used in different postures of the linear motor. In addition, the contact gap 22 is symmetrical along the symmetrical plane of the ball retaining plate 50, and the symmetrically arranged contact gap 22 can ensure a more stable contact between the ball and the stator slide rail 10, providing better operational stability.

In some embodiments, as shown in FIG. 7 to FIG. 9, the contact gap 22 located on the upper side of locating surface 52 faces diagonally upward; the contact gap 22 located on the lower side of locating surface 52 faces diagonally downwards.

It should be noted that the contact gap 22 on the upper side of the locating surface 52 faces diagonally upwards, and the contact gap 22 on the lower side of the locating surface 52 faces diagonally upward, and based on the above settings, the balls on both sides and the stator slide rail 10 form a splayed shape when they come into contact, so that the rotor 20 can be more stably disposed on the stator slide rail 10, and is less prone to vibration or shaking, providing in higher stability and higher accuracy of the linear motor during operation.

Preferably, the shape of the contact position between the stator slide rail 10 and the ball matches the shape of the ball. Thus achieving higher operational stability performance.

In some embodiments, as shown in FIG. 7 to FIG. 9, the ball is close to the upper or lower half of one side of the stator slide rail 10 and in contact with the stator slide rail 10.

It should be noted that the ball is close to the upper or lower half of one side of the stator slide rail 10 and in contact with the stator slide rail 10, on the one hand, reducing the overall size of the linear motor, and on the other hand, improving the stability performance of the ball during motion.

In some embodiments, as shown in FIG. 7 to FIG. 9, the ball retaining plate 50 has an installation hole 54, and is connected to the rotor 20 through the installation hole 54, making it more stable and secure.

In some embodiments, as shown in FIG. 7 to FIG. 9, a second fit surface 55 with the same shape as the stator slide rail 10 is provided on the opposite side of the locating surface 52, ensuring a plump shape of the ball retaining plate 50 and a tight space between the rotor 20 and the stator slide rail 10.

In some embodiments, as shown in FIG. 7 to FIG. 9, the end of the ball retaining plate 50 is in contact with the ball return end cap 60 to provide better sealing performance.

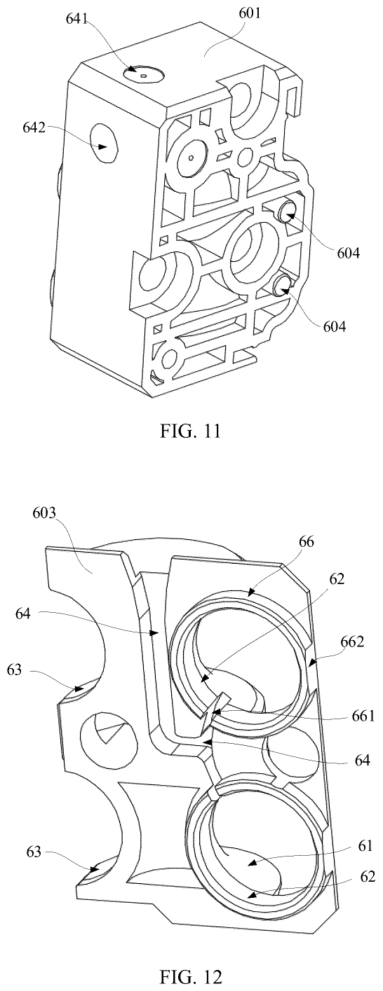

In some embodiments, as shown in FIG. 10 to FIG. 15, the ball-returning channel 61 has a first return port 62 and a second return port 63, the ball return end cap 60 is provided with an oil passage 64 connecting to the outside that communicates with the ball-returning channel 61.

The end cap body 601 has a ball-returning channel 61 through which the ball can enter/exit from the first return port 62 and exit/enter from the second return port 63. In addition, the oil passage 64 is disposed on the end cap body 601 and communicates with the ball-returning channel 61, so that lubricating oil can directly lubricate the interior of the ball circulating slide rail on the rotor 20, providing good lubrication for the balls; lubricating oil can also provide good lubrication for the ball-returning channel 61, ensuring smoother returning of the ball return end cap 60.

It should be noted that the ball return end cap 60, relative to other structural components on the rotor 20, is the component that comes into closest contact with the ball, with a larger contact surface 51 with the ball, and meanwhile, the balls in the ball return end cap 60 generate more abundant rotational motion than them in other positions, therefore the oil passage 64 disposed on the ball return end cap 60 can better achieve lubrication for the ball. In addition, it is precisely because of the closest contact between the ball return end cap 60 and the ball that the ball is extremely prone to jamming at the ball return end cap 60, therefore the oil passage 64 that is disposed on the ball return cover and connecting to the ball-returning channel 61 can also provide good lubrication for the ball-returning channel 61, making the ball return end cap 60 smoother during ball return.

It should also be noted that since the oil passage 64 is located on the end cap body 601 to avoid the additional arrangement of the oil passage 64 on other external lubrication structures, so that the end cap body 601 not only rotate rotating balls conventionally, but also has lubrication function. On the other hand, as the present application avoids the need for additional lubrication structures, the use of the ball return end cap 60 disclosed in the present application can reduce size and make the overall structure more compact.

Specifically, this embodiment does not limit the specific position of the oil passage 64 in the ball-returning channel 61, and the oil passage 64 can be connected to the middle of the ball-returning channel 61, or to any side of the middle of the ball-returning channel 61 and, of course, the oil passage 64 can also be connected to the first return port 62 or the second return port 63, thereby lubricating the ball and the ball-returning channel 61. Due to the lubricating oil carried on the ball, other positions where the ball reaches are also lubricated.

The present application does not limit the shape of the end cap body 601, and the shape of the end cap body 601 in the accompanying drawings is only one embodiment of the present application. In other embodiments, the shape of the end cap body 601 can be centrally symmetrical, so that both sides of the end cap body 601 can be connected to other structures such as the rotor 20. In addition, in other embodiments, the first return port 62 and the second return port 63 have the same shape and size, and their positions are symmetrical with respect to the center of the end cap body 601, so that the operator can decide to make the first return port 62 or the second return port 63 be closer to the stator slide rail 10, or the upper and lower positions of the first return port 62 and the second return port 63. It should also be noted that at least one ball-returning channel 61 is provided, and the number of first return ports 62 and second return ports 63 matches that of ball-returning channels 61.

In further, the oil passage 64 can be located inside the end cap body 601 and can be, in the form of notch 314, sealed with an external structure to form the oil passage 64. The oil passage 64 can also be disposed inside the end cap body 601 on one section, and disposed in a notchted form on the other section. In some embodiments, when the oil passage 64 is converted from a channel provided inside the end cap body 601 to a notchted form, the oil passage 64 is connected through the connecting port 643, and lubricating oil flows through the internal channel, connecting port 643, and the notch to the ball-returning channel 61 in sequence.

Specifically, the connection between oil passage 64 and the outside can be an external pipeline at the location of the external connection, through which lubricating oil enters oil passage 64; an oil box 41 can also be provided at an externally connected location to store lubricating oil that can flow into oil passage 64 for lubrication. In other embodiments, an oil storage material, which is used to store lubricating oil, may be provided inside the oil passage 64, and during the movement of the rotor 20, the lubricating oil on the oil storage material can be applied on the ball for lubrication, and after the lubricating oil on the oil storage material is used up, lubricating oil needs to be replenished at the position connected to the outside. Obviously, lubricating oil can also enter the oil passage 64 from the outside through other structures.

In some embodiments, as shown in FIG. 10 to FIG. 14, the oil passage 64 extends to the position of the first return port 62.

Specifically, at the position where the oil passage 64 extends to the first return port 62, for the two return ports in this embodiment, the return port connected to the oil passage 64 is the first return port 62, and the other is the second return port 63. The oil passage 64 is disposed at the first return port 62 so that the ball is more likely to be lubricated in the ball-returning channel 61, and is better lubricated as long as the ball enters the ball-returning channel 61. It should be noted that the rotor 20 can move back and forth on the stator slide rail 10, so the ball always has a chance to enter from the first return port 62 and leave from the second return port 63.

The position of the first directional port can be a notch 314 opened at the first return port 62, a through-hole on the side wall of the first return port 62 connected to the oil passage 64, or a lubrication ring opened in the circumferential direction of the first return port 62, so that the oil passage 64 and the first return port 62 are mutually communicated. It should be explained that the position of the first return port 62 or the position of the second return port 63 refers to a part of the area near the ball inlet and outlet, not merely the position of the ball inlet and outlet.

In some embodiments, as shown in FIG. 10 to FIG. 14, the first return port 62 and the second return port 63 are disposed horizontally, the first return port 62 is away from the stator slide rail, and the second return port 63 is close to the stator slide rail 10, so that the ball, after being lubricated by lubricating oil, can immediately slide in contact with the stator slide rail 10 and, on the one hand, more lubricating oil is carried to the stator slide rail 10, and on the other hand, the ball can be fully lubricated in the ball-returning channel 61, therefore the ball return end cap 60 provides better lubrication effect on the linear motor, enabling a smoother returning of the ball return end cap 60 and improving the operating accuracy of linear motor.

In other embodiments, the first return port 62 and the second return port 63 are disposed horizontally, the first return port 62 is close to the stator slide rail 10 and the second return port 63 is away from the stator slide rail 10, so that the ball, after lubrication at the first return port 62, immediately comes into contact with the stator slide rail 10, ensuring more lubricating oil at the stator slide rail 10, and the stator slide rail 10 is uniformly lubricated in this embodiment.

Uniform lubrication is applied to each ball without uneven lubrication, therefore a more uniform lubrication effect is provided for the stator slide rail 10 when the balls come into contact with the stator slide rail 10.

In some specific embodiments, as shown in FIG. 10 to FIG. 14, the oil passage 64 is a notch 314 opened on the surface of the end cap body 601 and extending to the first return port 62, and the notch 314 is configured to seal with the external structure to form the oil passage 64.

Specifically, oil passage 64 is a notch on the surface of the end cap, extending to the first return port 62, and the notch 314 can be combined with external structures to seal and form oil passage 64. The design of notch 314, on the one hand, can reduce the difficulty of providing oil passage 64 on the end cap body 601, and minimize the processing steps, especially for the case where branches of oil passage 64 are required, the processing difficulty is more complex for branch oil passages; on the other hand, the notch 314 design can make it more convenient for operators to clean oil stains. For some infrequently used ball return end cap 60 of linear motors, the long-term accumulation of lubricating oil in the oil passage 64 may cause blockage of the oil passage 64, while the notch 314 design can effectively facilitate cleaning operations for operators.

In addition, due to the open structure of the notch 314, the operator who intends to control the flow of lubricating oil can easily add a flow control structure inside the notch 314, such as an external gasket, to control the oil output by changing the cross-sectional area of the oil passage 64.

The notch 314 is disposed on the surface of the end cap body 601, so that the end cap body 601 has higher structural strength, making it less prone to deformation and damage.

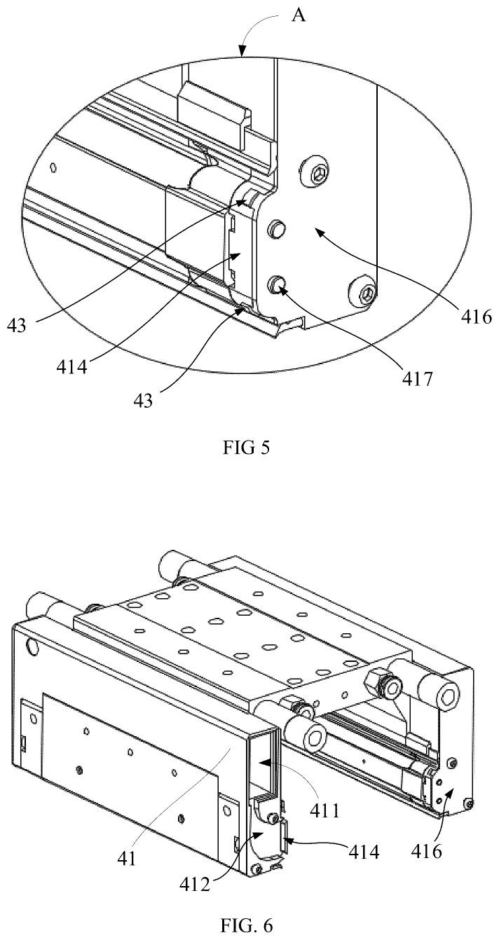

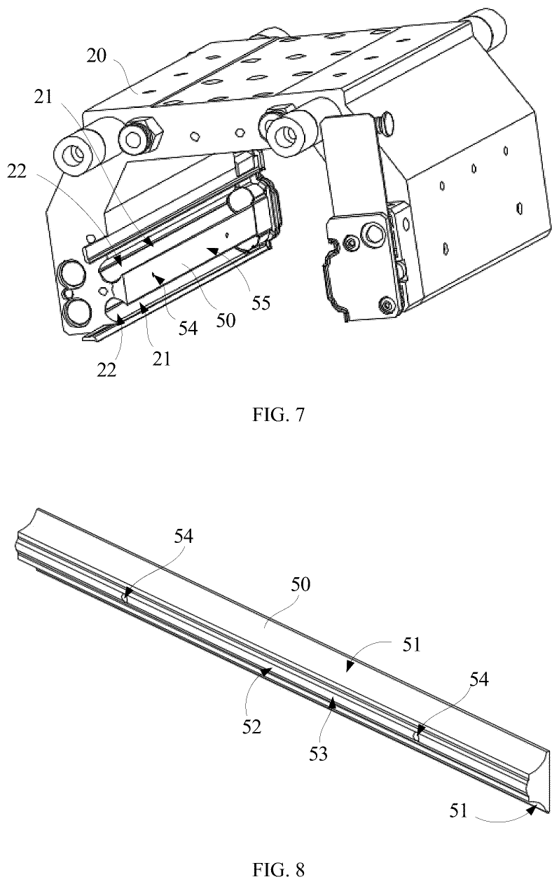

In some specific embodiments, as shown in FIG. 1 to FIG. 12, the first return port 62 protrudes outward from the end cap body 601 to form an installation portion 66.

Specifically, the first return port 62 protrudes outward from the end cap body 601 to form an installation portion 66, the installation portion 66 facilitates the installation of rotor 20, improves the simplicity of assembly process, and also play a certain limiting role. In addition, the installation portion 66 can improve the sealing performance of ball return end cap 60 and rotor 20, preventing the leakage of lubricating oil.

Preferably, a first limiting portion 662 is also provided at the installation portion 66 to prevent the rotation of installation portion 66 when the installation portion 66 is installed on the rotor 20, thereby improving the installation accuracy of ball return end cap 60.

In some embodiments, as shown in FIG. 11, the end cap body 601 is provided with a second limiting portion 604 to ensure a more tight fit between the ball return end cap 60 and other structures. Preferably, the second limiting portion 604 has two protrusions that can be integrated with the ball return end cap 60.

Preferably, an installation fit portion 23 can be provided on the rotor 20, and the installation portion 66 and the installation fit portion 23 fit with each other to provide better sealing effect, and connect and fix the ball return end cap 60 better.

In other embodiments, an installation portion 66 protruding outward from the end cap body 601 may also be provided at the second return port 63.

In some embodiments, the end cap body 601 has a through hole, and the operator can fix the end cap body 601 and rotor 20 using bolts.

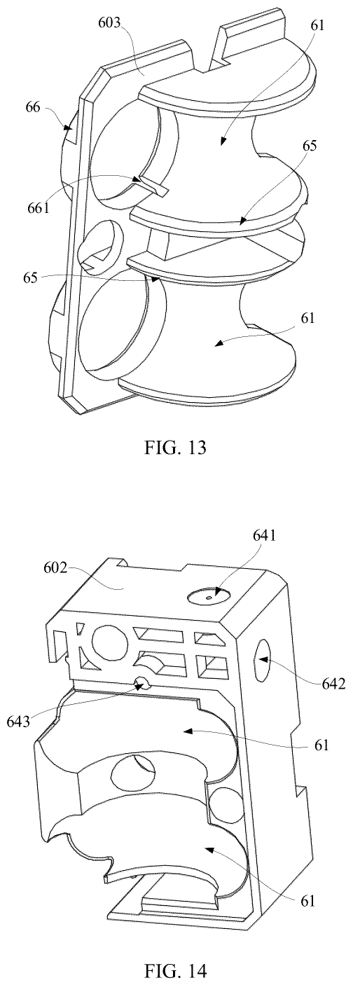

In some more specific embodiments, as shown in FIG. 10, FIG. 12 and FIG. 13, the installation portion 66 is provided with a gap 661, and the oil passage 64 communicates with the gap 661.

In further, the installation portion 66 has a gap 661, and the oil passage 64 communicates with the gap 661, the opening located at the installation portion 66 can avoid the arrangement of hole at other positions of the first return port 62 and, it should be noted that during the process of circulating the ball, the rotating ball, during returning process, will cause a certain degree of impact force on the ball return end cap, especially at the position where the ball direction changes, that is, at the rotation position of the ball-returning channel 61. Therefore, the hole connected to the oil passage 64 at the gap 661 of installation portion 66 can avoid damage caused by the impact force of the ball, and the service life of the ball return end cap 60 can be extended because of its higher structural strength.

In some embodiments, as shown in FIG. 10 to FIG. 14, at least two ball-returning channels 61 are provided, and multiple ball-returning channels 61 communicate with the oil passage 64.

Specifically, compared to a single ball-returning channel 61, the arrangement of at least two ball-returning channels 61 can provide rotor 20 with higher stability during operation, but it should be noted that the number of ball-returning channels 61 is limited by manufacturing costs and the size of rotor 20, so the number of ball-returning channels 61 should be selected according to specific needs.

Multiple ball-returning channels 61 communicate with oil passage 64, so that each ball-returning channel 61 is lubricated by lubricating oil.

Preferably, as shown in FIG. 10 and FIG. 12, oil passage 64 includes a main oil passage 64 and at least two branch oil passages 64, one end of the main oil passage 64 communicates with the outside, and the other end communicates with multiple branch oil passages 64, allowing lubricating oil to be added from one point in the main oil passage 64. In other embodiments, the branch oil passage 64 can also be connected to another branch oil passage 64 for flow control.

In other embodiments, multiple oil passages 64 may be provided to communicate with multiple ball-returning channels 61, or may communicate with different positions in a ball-returning channel 61.

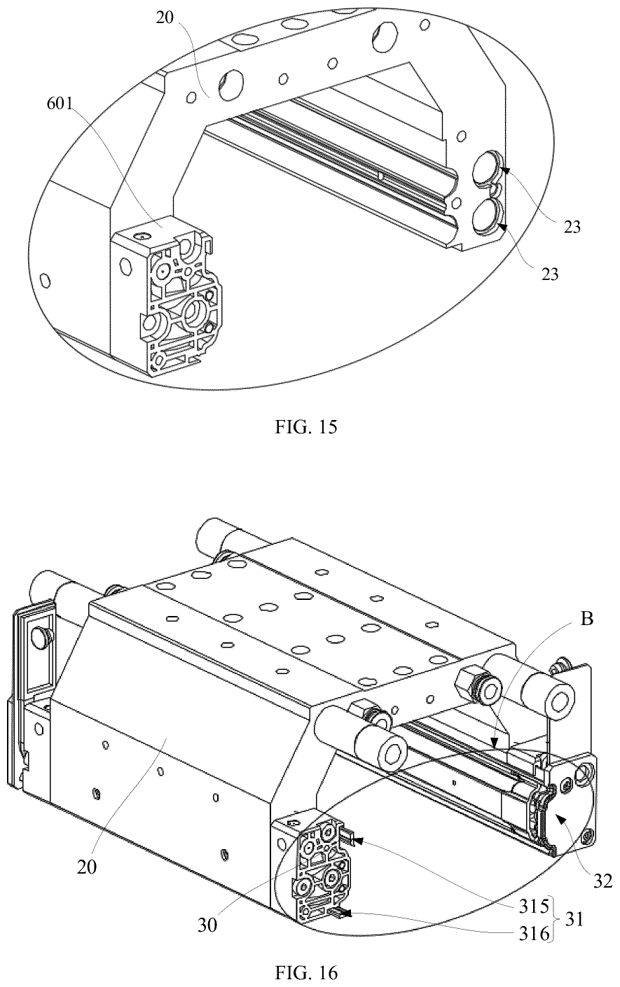

In some embodiments, as shown in FIG. 10, FIG. 11, FIG. 14 and FIG. 15, the end cap body 601 has a first oil inlet 641, the end cap body 601 is connected to an oil box 41, and the oil box 41, first oil inlet 641, and oil passage 64 are sequentially connected.

It should be noted that the end cap body 601 has a first oil inlet 641 that can be integrated with an external oil box 41 to achieve lubrication function without the need for external components, reducing the size of rotor 20 and making the overall structure more compact.

Preferably, as shown in FIG. 10, FIG. 11, FIG. 14 and FIG. 15, the end cap body 601 also has a second oil inlet 642 that can be connected to external pipelines for adding lubricating oil, the end cap body 601 has a first oil inlet 641 and a second oil inlet 642, which can be selected according to the user's specific usage needs, thereby improving the adaptability of ball return end cap 60.

The present invention also discloses a linear motor, as shown in FIG. 15, comprising a stator slide rail 10 and a rotor 20 that slidably fits on the stator slide rail 10, comprises a ball return end cap 60 connected to the rotor 20.

Based on the installation of the ball return end cap 60 disclosed in the present application, the linear motor can achieve better lubrication effect and ball return effect, higher accuracy, smaller volume, and more compact structure.

In some embodiments, as shown in FIG. 10, FIG. 12 and FIG. 13, the ball-returning channel 61 is provided with a groove structure 65 that is inwardly recessed away from the ball-returning channel 61, and the groove structure 65 is disposed along the direction of ball return path of the ball-returning channel 61.

It should be noted that, the ball-returning channel 61 is provided with a groove structure 65 that is inwardly recessed away from the ball-returning channel 61, and the groove structure 65 is disposed along the direction of ball return path of the ball-returning channel 61, the groove structure 65 can provide certain guidance for the balls and, to a certain extent, alleviate some of the pressure concentrated on the wall of the ball-returning channel 61, so that the ball return end cap 60 provides better ball returning effect. Preferably, the groove structure 65 is located at the bottom and/or top of the ball-returning channel 61 and, due to the self gravity of the ball, placing groove structure 65 at the bottom and/or top of the ball-returning channel 61 can improve its ball returning effect.

It should be explained that the size of groove structure 65 relative to the ball-returning channel 61 cannot be too large, otherwise better ball return effect cannot be achieved when most part of the ball is trapped in the groove structure 65.

Preferably, as shown in FIG. 10, FIG. 12 and FIG. 13, compared to the groove structure 65, the groove structure 65, a chamfered structure, has a smoother contact surface 51 with the ball and higher structural strength, making it less prone to damage. Specifically, the angle range for opening chamfer structures is between 10° and 80° (the normal angle range for chamfers is between 0° and 90)°.

In some embodiments, as shown in FIG. 10 to FIG. 14, the end cap body 601 comprises an end cover plate 602 and a ball return plate 603, and the end cover plate 602 and the ball return plate 603 together form the ball-returning channel 61.

During the movement of rotor 20, the impact force of the ball is mainly concentrated at the rear end of end cap body 601, so the end cover plate 602 is more prone to damage compared to the ball return plate 603, and therefore the vulnerable parts can be replaced conveniently by separating the end cap body 601 into end cover plate 602 and ball return plate 603.

In some specific embodiments, as shown in FIG. 10 to FIG. 14, one of the end cover plate 602 and ball return plate 603 is, at their joint position, provided with a groove structure 65 that is inwardly recessed away from the ball-returning channel 61, and the groove structure 65 is disposed along the direction of ball return path of the ball-returning channel 61.

Specifically, if the end cap body 601 is integrally formed, opening groove structure 65 will face higher difficulty, while the independent arrangement of the end cover plate 602 and ball return plate 603 can make it easier to process and open the groove structure 65. In addition, to make groove structure 65 more easily, groove structure 65 is disposed at the joint position of one of the end cover plate 602 and ball return plate 603, that is, the edge position of end cover plate 602 or ball return plate 603.

Preferably, compared to the groove structure 65, the groove structure 65, a chamfered structure, has a smoother contact surface 51 with the ball and higher structural strength, making it less prone to damage. Specifically, the angle range for opening chamfer structures is between 10° and 80° (the normal angle range for chamfers is between 0° and 90)°.

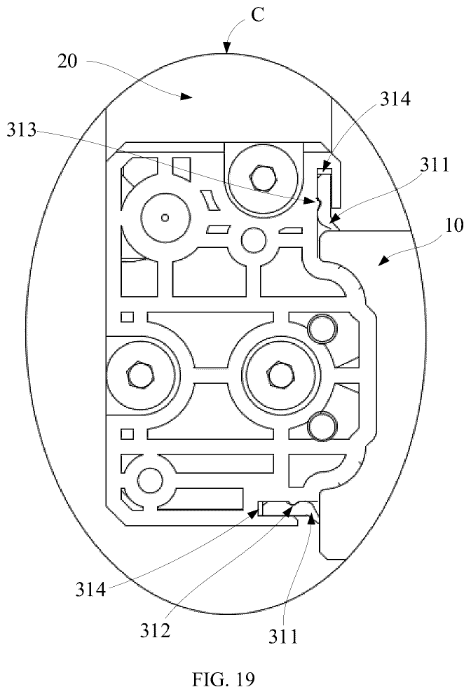

In some embodiments, as shown in FIG. 16 to FIG. 19, the sealing module comprises a first sealing unit 31, and the rotor 20 is connected to the first sealing unit that maintains sealing contact with the stator slide rail 10, the first sealing unit 31 extends towards both ends along the sliding direction of the rotor 20 and is in contact with both ends of the rotor 20, and the rotor 20, the first sealing unit 31, and the stator slide rail 10 together form a sealed space.

The first sealing unit 31 is disposed on the rotor 20 and contacts the stator slide rail 10 to seal the sliding position of the rotor 20, the first sealing unit 31 also extends along the sliding direction of the rotor 20 to both ends to seal more positions, finally, the first sealing unit 31 contacts both ends of the rotor 20 to completely seal the rotor 20 and, within the sealing range of the first sealing unit 31, lubricating oil cannot flow out through the first sealing unit 31. Compared with prior art, the linear motor disclosed in the present application can better seal the lubricating oil inside the track 11.

It should be noted that in cases of poor sealing performance and high-speed operation of linear motors, lubricating oil may be sprayed onto other parts of the motor, other equipment, or even manufactured products, making cleaning and maintenance difficult. In addition, lubricating oil used is to lubricate the space between the rotor 20 and the stator slide rail 10, and lubricating oil overflowing due to poor sealing performance will result in insufficient lubrication between the rotor 20 and the stator slide rail 10, affecting the use of linear motor because of a decreased accuracy.

Specifically, when the first sealing unit 31 is used for sealing purpose, it is necessary to ensure that the rotor 20, the first sealing unit 31, and the stator slide rail 10 are in the enclosed space, and other positions are also sealed, and if there is a through-hole on the rotor 20 in the enclosed space, lubricating oil will flow out from the through-hole, thus failing to achieve the sealing effect, therefore it is necessary to form a sealed space between the rotor 20, the first sealing unit 31, and the stator slide rail 10.

The first sealing unit 31 abuts against both ends of the rotor 20 to seal the rotor 20 to the maximum extent and scope, and the overflow range of lubricating oil is also within the coverage range of the first sealing unit 31. In addition, the positions with the most lubricating oil overflow often occur at the two ends of the rotor 20, since the linear motion of the linear motor will cause the accumulation of lubricating oil at the two ends of the rotor 20, and overflow will occur as long as a certain amount of lubricating oil is accumulated. Therefore, extending the first sealing unit 31 to the two ends of the rotor 20 is a structural feature according to the motion law of the equal stroke structure of linear motor.

It should also be noted that only a sufficient amount of lubricating oil is often applied for lubricating a linear motor, and the mass of lubricating oil is often not too high, therefore the first sealing unit 31 abuts against the two ends of the rotor 20, which is sufficient to seal the lubricating oil flowing to the area and make assembly simpler.

In addition, the first sealing unit 31 extends towards both ends along the sliding direction, and the end of its rotor 20 can be sealed by other sealing structures, and if it is necessary to make the first sealing unit 31 have the function of end seal 415, the first sealing unit 31 can be merely bent along the thickness direction of stator slide rail 10.

In the present application, the stator slide rail 10 has a top surface, a bottom surface, and two side surfaces. The surface close to the rotor 20 is the top surface, the surface opposite to the top surface is the bottom surface, the surface parallel to the sliding direction of the rotor 20 is the side surface, and the surface perpendicular to the sliding direction of the rotor 20 is the cross-section. The thickness direction of stator slide rail 10 refers to the direction of the vertical line connecting the top and bottom surfaces. The two sides of the stator slide rail 10 refer to the direction of vertical connection between the top and bottom surfaces. In addition, the drawings in the present application do not limit the types of linear motors, and obviously, other types of linear motors can also be used.

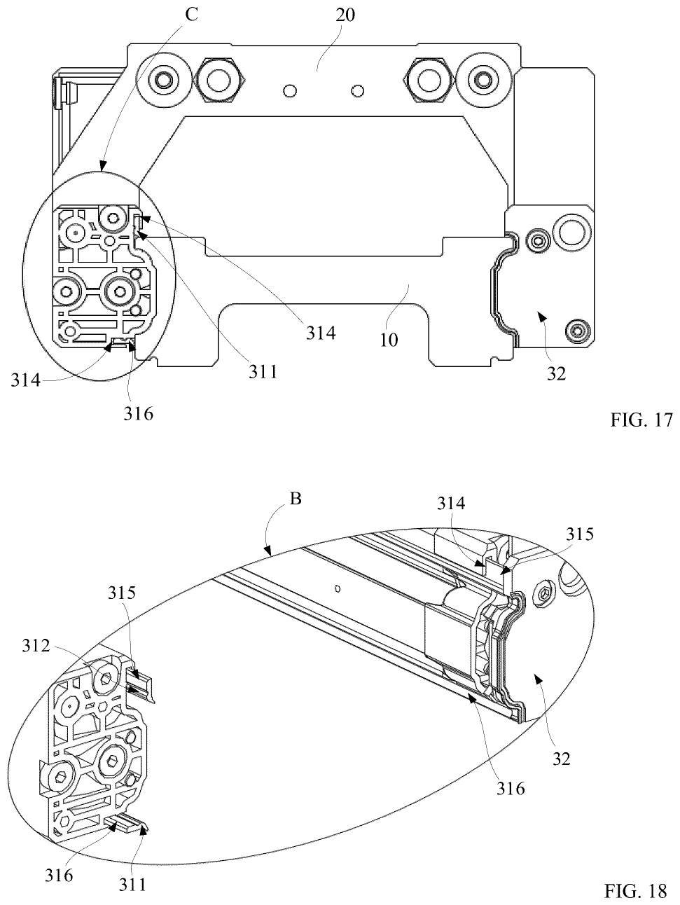

In some specific embodiments, as shown in FIG. 17 and FIG. 19, the surface of the stator slide rail 10 in contact with the first sealing unit 31 is the contact surface 51, and the first sealing unit 31 is perpendicular to the contact surface 51.

It should be noted that sealing contact exists between the rotor 20 and the stator slide rail 10, however, if the contact is unstable, some lubricating oil may still flow out, therefore ensuring stable contact between the rotor 20 and the stator slide rail 10 is also a key step in achieving good sealing. Arranging the first sealing unit 31 perpendicular to the contact surface 51 can make the pressure generated by the first sealing unit 31 perpendicular to the contact surface 51 and, on the one hand, tight contact is maintained between the first sealing unit 31 and the stator slide rail 10 and, on the other hand, when the rotor 20 and/or the stator slide rail 10 move, the first sealing unit 31 and the stator slide rail 10 can also tightly contact each other without affecting their sealing performance.

In some embodiments, as shown in FIG. 16 to FIG. 19, the first sealing unit 31 has a curved end 311 that bends towards one side, and the first sealing unit 31 contacts the stator slide rail 10 through the curved end 311.

Specifically, the first sealing unit 31 has a curved end 311 that bends towards one side, the curvature angle of the curved end 311 can change the position of sealing contact between the first sealing unit 31 and the stator slide rail 10, providing better fit with other structures on the linear motor; compared to the absence of curved end 311, the arrangement of curved end 311 can provide more elastic space for the first sealing unit 31 in its arrangement direction, and improve its sealing effect during the operation of linear motor; in addition, a certain amount of lubricating oil can be stored in the bending space of the curved end 311 or the space enclosed by the curved end 311 and the stator slide rail 10, so that the lubricating oil is not easy to overflow and further sealed better.

In some specific embodiments, as shown in FIG. 16 to FIG. 19, the curved end 311 bends outwards the rotor 20 in a direction away from the rotor 20.

It should be noted that the curved end 311 of the first sealing unit 31 can be in contact with the stator slide rail 10 in different directions, and in addition, the curved end 311 can be bent outward away from the rotor 20, so that operators can more easily clean the linear motor, without affecting the normal operation of the linear motor due to the formation of a cleaning dead zone at the curved end 311 and dust accumulation. In this embodiment, the curvature of the curved end 311 towards the outside of the rotor 20 in the direction away from the rotor 20 can be explained based on the direction in which the curved end 311 is oriented in the drawing.

In some embodiments, as shown in FIG. 16 to FIG. 19, one of the first sealing unit 31 and the rotor 20 is provided with a slot 312, and the other is provided with a locating protrusion 417/313, and the slot 312 and the locating protrusion 417/313 fit with each other.

Specifically, the first sealing unit 31 is connected to the rotor 20 through the mutual cooperation between the locating protrusion 417/313 and the slot 312, the locating protrusion 417/313 and the slot 312 have the advantages of simple structure, reliable fit, and easy assembly, and the operator can conveniently disassemble and replace the first sealing unit 31.

In some specific embodiments, as shown in FIG. 16 to FIG. 19, the rotor 20 has a notch 314 opened along the sliding direction, and the first sealing unit 31 is assembled in the notch 314, and the slot 312 and the locating protrusion 417/313 fit with each other in the notch 314.

It should be noted that the rotor 20 has a notch 314 opened along the sliding direction, and the first sealing unit 31 can be assembled in the notch 314, and the slot 312 and locating protrusion 417/313 are fitted in the notch 314 and on the one hand, the fixing effect of the first sealing unit 31 is improved, and on the other hand, locating protrusions 417/313 and notches 314 are avoided in other positions, and multiple structural combinations can be assembled to ensure a more stable connection and fixation of the first sealing unit 31.

Preferably, as shown in FIG. 17 and FIG. 19, the width of notch 314 is the same as the thickness of the first sealing unit 31, so that a fit connection is realized between the notch 314 and the first sealing unit 31 to further improve connection stability.

Preferably, as shown in FIG. 17 and FIG. 19, a certain margin space is provided at the bottom of notch 314 to prevent machining error of the first sealing unit 31, which may cause installation failure.

In some more specific embodiments, as shown in FIG. 16 to FIG. 19, the locating protrusion 417/313 is a strip-shaped protrusion along the sliding direction, and the slot 312 and the strip-shaped protrusion fit with each other.

Specifically, the locating protrusion 417/313 is a strip-shaped protrusion along the sliding direction, and since the slot 312 and the strip-shaped protrusion fit with each other, the slot 312 is also a strip-shaped slot 312, and when installing the first sealing unit 31, the operators should insert the first sealing unit 31 into the rotor 20 along the sliding direction. Compared to the locating protrusions 417/313 such as convex points and bumps, the strip-shaped protrusion has a better limiting effect in directions other than the sliding direction.

In some specific embodiments, as shown in FIG. 16 to FIG. 19, the first sealing unit 31 includes a first sealing element 315 and a second sealing element 316, which are disposed on both sides of the stator slide rail 10, respectively.

It should be noted that, for some linear motors without an oil trap at the bottom, the first sealing element 315 and second sealing element 316 should be installed on both sides of stator slide rail 10 for the purpose of top sealing and bottom sealing.

Preferably, as shown in FIG. 16 to FIG. 19, the first sealing element 315 and second seal element 316 are both sealing strips, which may be made of metal, fabric, felt, or polymer materials. Obviously, in other embodiments, the first sealing unit 31 may also be a sealing strip.

In some specific embodiments, as shown in FIG. 17 and FIG. 19, the stator slide rail 10 has a top surface and a side surface adjacent to the top surface, the first sealing element 315 is in contact with the top surface and the second sealing element 316 is in contact with the side surface.

Specifically, the second sealing element 316 is in contact with the side surface of stator slide rail 10 and, on the one hand, the second sealing element 316 can be closer to the sliding position of the rotor 20 on the stator slide rail 10, and on the other hand, the height increase caused by contact with the bottom surface and the inconvenient placement of linear motor can be avoided.

In some specific embodiments, as shown in FIG. 16 to FIG. 19, the end of the rotor 20 has a second sealing unit 32, and the edge of the second sealing unit 32 is in sealing contact with the stator slide rail 10, and the first sealing unit 31 abuts against one side of the second sealing unit 32.

It should be noted that the end of the rotor 20 has a second sealing unit 32, the edge position of the second sealing unit 32 is in sealing contact with the stator slide rail 10, and the edge shape of the second sealing unit 32 can be defined according to the specific shape of the stator slide rail 10 for the purpose of sealing the stator slide rail 10 and the end of the rotor 20 slide rail. The first sealing unit 31 abuts against one side of the second sealing unit 32 to avoid the arrangement of other structures on the rotor 20 due to the contact with the first sealing unit 31, realizing structural optimization.

Specifically, if the first sealing unit 31 includes a first sealing element 315 and a second sealing element 316, the first sealing element 315 and the second sealing element 316 are respectively disposed on both sides of the stator slide rail 10. In the sealed space composed of the second sealing unit 32, the first sealing element 315, the second sealing element 316, the rotor 20, and the stator slide rail 10, lubricating oil can circulate inside the sealed space with the movement of the linear motor, thereby improving the operating accuracy of linear motor.

In some specific embodiments, as shown in FIG. 1 to FIG. 6, the lubrication module 40 comprises an oil box 41, an oil guide component 413, and a lubrication unit 43, and the linear motor is connected to the oil box having an oil storage chamber 411, and the oil storage chamber 411 internally has an oil guide component 413, the oil guide component 413 has a buffer surface 4131 and an oil guide end 4132 extending from the buffer surface towards the opposite side, and the oil guide component 413 is connected to the lubrication unit 43 that is used for linear motor lubrication.

The oil storage chamber 411 internally has an oil guide component 413, the oil guide component 413 has a buffer surface 4131 and an oil guide end 4132 extending from the buffer surface 4131 towards the opposite side, so that the oil guide component 413 have multiple directions in the oil storage chamber 411 for sucking lubricating oil, and regardless of how the linear motor is placed or disposed, lubricating oil can be sucked through the oil guide component 413. In addition, the oil guide component 413 can also store a certain amount of lubricating oil, making it difficult for the lubrication unit 43 to dry out, causing damage to the lubrication unit 43, and providing a certain buffering effect before the lubricating oil enters the lubrication unit 43. Compared with the prior art, the linear motor disclosed in the present application can improve lubrication stability.

Specifically, the buffer surface 4131 can be a plane or a curved surface, and can also be formed by two connected non parallel bar structures. The arrangement of buffer surface 4131 is to allow the absorption of lubricating oil through infiltration in any two directions and, along with the oil guide end 4132, the oil guide component 413 can absorb lubricating oil in the third direction, so that the oil guide component 413 can, regardless of the position of the oil box 41, come into contact with the lubricating oil in the oil storage chamber 411 and provide oil to the lubrication unit 43 for linear motor lubrication.

The drainage end extends towards the opposite side of buffer surface 4131, that is, the extending direction of the drainage end is on the side away from the buffer surface 4131 and, it should be explained that the present application does not limit whether the drainage end needs to extend perpendicular to the buffer surface 4131.

It should be noted that the lubrication unit 43 can communicate with the buffer surface 4131 or with the oil guide end 4132.

In some specific embodiments, as shown in FIG. 2, the buffer surface 4131 and oil guide end 4132 are in contact with the inner walls on both sides of the oil storage chamber 411, respectively.

It should be noted that the buffer surface 4131 and oil guide end 4132 are in contact with the inner walls on both sides of the oil storage chamber 411, respectively, so that the lubricating oil, regardless of the side of oil storage chamber 411 where it is accumulated, can be absorbed by the oil guide component 413, and the oil guide component 413 can absorb lubricating oil in the oil storage chamber 411 to the maximum extent.

In some specific embodiments, as shown in FIG. 2, there are at least two buffer surfaces 4131, and multiple buffer surfaces 4131 are connected through the oil guide end 4132.

It should be noted that multiple buffer surfaces 4131 can be provided to achieve better ability to absorb lubricating oil. It should also be explained that the oil guide component 413 cannot occupy a large volume in the oil storage chamber 411, which will result in a decreased oil storage capacity of the oil box 41.

In some specific embodiments, as shown in FIG. 2, the oil guide component 413 has the same shape and size as the oil storage chamber 411.

It should be noted that the oil storage chamber 411 has the same shape and size as the oil guide component 413, for example, if the oil storage chamber 411 is spherical, then the oil guide component 413 is also spherical and of the same size; if the oil storage chamber 411 is a hexahedron, then the oil guide component 413 is also a hexahedron and has the same size, so that the lubricating oil, regardless of its location in the oil storage chamber 411, can be absorbed through the oil guide component 413, providing more stable lubrication for the linear motor.

In some embodiments, the oil guide component 413 is an oil guide sponge.

It should be noted that the oil guide component 413 is an oil guide sponge, which is inexpensive and has strong oil absorption and storage capabilities. In other embodiments, the oil guide component 413 can also be made of oil guide felt or other polymer materials.

In some specific embodiments, as shown in FIG. 1 to FIG. 6, oil box 41 is connected to rotor 20, and lubrication unit 43 is in contact with track 11 of stator slide rail 10.

The oil box 41 slides together with the rotor 20, and an oil storage chamber 411 for storing lubricating oil is provided on the oil box 41, and the oil box 41 is then connected to the oil storage chamber 411 through the lubrication unit 43, and finally contact is realized between the lubrication unit 43 and the track 11, so that the lubrication unit 43 can slide together with the rotor 20 and, during the sliding process of the rotor 20, the lubrication unit 43 can directly contact the track 11 to complete the lubrication of the entire track 11, so that suitable lubricating oil is released at every place on the track 11 based on the flow rate control of the lubrication unit 43, and the lubricating oil is evenly released to provide better lubrication effect. Compared with prior art, the linear motor disclosed in the present application can also improve lubrication effect.

Specifically, the lubrication unit 43 is in direct contact with the track 11 and, in addition to improving the lubrication effect, the lubrication unit 43 can choose the contact position with the track 11 according to its shape, enabling more precise application of lubricating oil; Meanwhile, as the lubrication unit 43 slides along with the rotor 20, the rotor 20 can immediately realize lubrication after the lubrication unit 43 releases lubricating oil, therefore the linear motor disclosed in the present application can also realize rapid lubrication.

Due to the built-in oil storage chamber 411 on the oil box 41, it is unnecessary for the oil box to communicate with external oil storage equipment to get lubricating oil from the outside, so that the linear motor is suitable for various usage scenarios. It should be explained that the oil box 41 referred to in the present application can be a separate structural component or a part of some structures that make up the rotor 20 and, for example, the rotor 20 has protective shells on both sides, and the oil storage chamber 411 can be provided on the protective shells and, in this case, the protective shell is the oil box 41 in the present application.

It should be noted that the lubrication unit 43 can be fabric, sponge, brush, or dropper structure, and when fabric, sponge, or brush is selected as the lubrication unit 43, the lubrication unit 43 is connected to the oil storage chamber 411 and lubricating oil can be applied onto the track 11. When a dropper is used as the lubrication unit 43, the dropper head can be in contact with the track 11, and the dropper head releases lubricating oil when the rotor 20 slides, the dropper head is compressed without releasing lubricating oil when the rotor 20 does not slide. In other embodiments, an electrically controlled lubrication unit 43 can also be used for track 11 lubrication, and during lubrication, the lubrication unit 43 is driven to communicate with the oil storage chamber 411 and release lubricating oil to lubricate the track 11.

In addition, the present application does not limit the position of the oil box 41 and lubrication unit 43 on the rotor 20, the oil box 41 and lubrication unit 43 can be installed in the same place (for the convenience of installation and removal), or installed separately in different places. The oil box 41 and lubrication unit 43 can be installed in the length direction of the rotor 20, the width direction of the rotor 20, or above or below the top of the rotor 20.

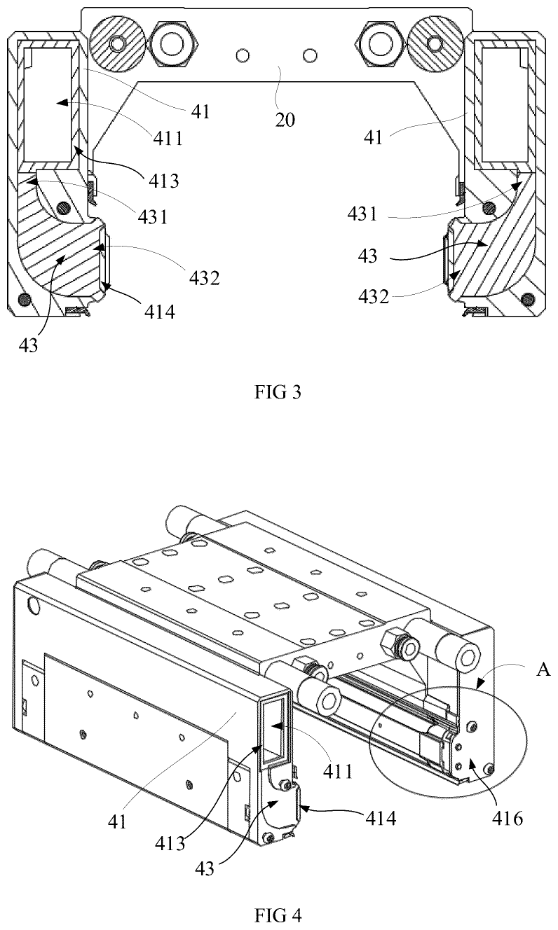

In some embodiments, as shown in FIG. 1 and FIG. 3, the stator slide rail 10 and the rotor 20 maintain sliding contact through the sliding surface 12, and the lubrication unit 43 is in contact with the sliding surface 12.

It should be noted that the lubrication unit 43 directly contacts the sliding surface 12, making lubrication simpler and more efficient, so that every position on the sliding surface 12 is properly lubricated with better lubrication performance.

In other embodiments, the lubrication unit 43 can also come into contact with the upper part of the sliding surface 12, so that the lubricating oil can flow onto the sliding surface 12 under the action of gravity, thereby lubricating the track 11.

In some embodiments, as shown in FIG. 3 to FIG. 6, the lubrication unit 43 is an oiling fabric, the first end 431 of the oiling fabric communicates with the oil guide component 413, and the second end 432 of the oiling fabric is in contact with the track 11.

It should be noted that the lubrication unit 43 is an oiling fabric, and the lubricating oil in the oil storage chamber 411 can infiltrate the oiling fabric and when in contact with the track 11, the lubricating oil can be applied to the track 11, thereby performing lubrication, the oiling fabric, on the one hand, is lighter in weight, and shows no significant weight increase when loaded on the rotor 20, and has lower costs and, on the other hand, the oiling fabric is used based on the permeability of lubricating oil, so it is unnecessary to load other mechanical structures for lubrication coating, making the overall structure simpler.

Specifically, the oiling fabric has a first end 431 and a second end 432, the first end 431 is used to adsorb lubricating oil in the oil storage chamber 411, and the second end 432 is used to apply lubricating oil; by controlling the size ratio of the first end 431 and the second end 432, and based on other installation structures (such as the oiling chamber 412 below), the operator can control the oil flow rate of lubricating oil to meet different usage scenarios.

Oiling fabrics can be selected from silk, cotton, Oxford cloth, linen, blended, flannel, or felt.

In some specific embodiments, the oiling fabric is oiling felt.

Specifically, the oiling fabric should be the oiling felt with good elasticity, structural stability, thermal insulation, and wear resistance and, during the lubrication process, the heat generated by friction with track 11 will not affect the oiling felt and, due to the tight and stable structure, the oiling felt has a long service life. More importantly, the fibers on the oiling felt are not easy to fall off, so there will be no fiber residue on track 11 that may affect the sliding accuracy of rotor 20 and the stroke accuracy of rotor 20.

In some specific embodiments, as shown in FIG. 3 to FIG. 6, the oil box 41 has an oiling chamber 412 communicating with the oil storage chamber 411, and the oiling chamber 412 has at least one section size the same as that of the oiling fabric, and the oiling fabric is assembled inside the oiling chamber 412 at the same cross-sectional size.

Specifically, the oiling chamber 412 has at least one section size the same as that of the oiling fabric, and the oiling fabric is assembled into the oiling chamber 412 at the location to prevent lubricating oil from flowing out from other positions. In addition, the arrangement of oiling chamber 412 can not only ensure the stable installation of oiling fabric, but also make the rotor 20 with more compact structure and smaller volume.

It should be noted that the present application does not limit the position of the oiling fabric relative to the oil storage chamber 411 and, in other embodiments, the oiling fabric can be placed above the oil storage chamber 411, and the lubricating oil in the oil storage chamber 411 can also penetrate upward along the oiling fabric.

In some more specific embodiments, as shown in FIG. 3 to FIG. 6, the oiling chamber 412 and oiling fabric have consistent shape and size, and the first end 431 is smaller than the second end 432.

Specifically, the oiling chamber 412 and oiling fabric have consistent shape and size to ensure that the oiling fabric remains stable within the oiling chamber 412, without any movement, deformation, or compression. In addition, the first end 431 of the oiling fabric is smaller than the second end 432, so that the lubricating oil seeping in from the first end 431 can be dispersed throughout the second end 432, less lubricating oil is applied to the track 11 and the oil flow rate is properly controlled.

In some more specific embodiments, as shown in FIG. 3 to FIG. 6, the oil storage chamber 411 and the oiling fabric are disposed vertically, and the oil storage chamber 411 is located above the oiling fabric.

It should be noted that the oil storage chamber 411 is located above the oiling fabric, creating a certain pressure at the first end 431 of the oiling fabric, so that it is easier for lubricating oil to penetrate into the oiling fabric to provide stable oil discharge at the second end 432.

In some embodiments, the oil storage chamber 411, oiling chamber 412, and oil guide component 413 are sealed by an oil baffle 416, and the oil box 41 includes the oil baffle 416.

In some specific embodiments, one of the oil box 41 and the oil baffle 416 has a protruding structure, and the other has a recessed structure, and both the protruding structure and the recessed structure fit with each other to realize locating between oil box 41 and oil baffle 416. Preferably, the protruding structure consists of at least two locating pins.

In some embodiments, one of the oil box 41 and the linear motor has a protruding structure, and the other has a recessed structure, and both the protruding structure and the recessed structure fit with each other to realize locating between oil box 41 and linear motor. Preferably, the protruding structure consists of at least two locating pins.

In some embodiments, the oil box 41 has a sealing strip that is independently disposed compared to other sealing structures on the linear motor and, when the oil box 41 is connected to the linear motor, the oil box 41 can be sealed with other structures through the sealing strip, and the sealing strip is pressed between the oil box 41 and the linear motor. The independent sealing strip facilitates the disassembly and assembly of oil box 41 for proper adaption. In other embodiments, the oil box 41 can also be sealed through other sealing structures provided on the linear motor.

In some embodiments, the outer side of the oil baffle 416 is connected with an end seal 415, and the side of the end seal 415 adjacent to the track 11 has a shape consistent with the track 11, which prevents the ingress of external dust and protects the lubrication unit 43.

In some embodiments, the outer side of the oil baffle 416 has a locating protrusion 417/313 connecting to the end seal 415, thereby locating the end seal 415 and providing more secure connection.

In some specific embodiments, as shown in FIG. 3 to FIG. 6, the oil box 41 is provided with a barrier portion 414, and the barrier portion 414 is located at the second end 432 and partially obstructed between the track 11 and the second end 432.

It should be noted that the oil box 41 is provided with a barrier portion 414, and the barrier portion 414, on the one hand, can limit the contact position between the oil guide component 413 and the track 11, and cover and protect some places where lubricating oil is not needed and, on the other hand, the barrier portion 414 can also further control the output of lubricating oil by limiting the oil flow rate.

In some embodiments, as shown in FIG. 1 to FIG. 6, the oil box 41 is connected to the end of the rotor 20 along the sliding direction of the rotor 20.

Specifically, along the sliding direction of the rotor 20, the oil box 41 is connected to the end of the rotor 20, and the connection between the oil box 41 and the end of the rotor 20 facilitate oil addition, repair, and replacement of the oil box 41 and, in addition, since the oil box 41 is disposed at the end of the rotor 20, the lubrication unit 43 slides closely behind the rotor 20 at the lubrication point after lubrication, providing better lubrication performance.

Preferably, two oil storage chambers 411 are provided along the sliding direction of the rotor 20, located at both ends of the rotor 20, so that regardless of which direction the rotor 20 slides in, the rotor can be lubricated by the lubrication unit 43 in advance.

Preferably, the oil box 41 is in an arch shape, wherein the oil box 41 has an arch shaped hole, and the shape and size of the arch shaped hole match that of the rotor 20 at the installation location of the oil box 41. In addition, oil storage chambers 411 are provided at both ends of the oil box 41, providing a more pleasing appearance and a more compact connection with the rotor 20. The arched structure can also better provide oil storage chambers 411 at both ends of the rotor 20, respectively, making it more convenient to arrange oil storage chambers 411, while also facilitating the installation of oil box 41 and protecting the rotor 20.

In the description of the present specification, the reference to the terms “one embodiment”, “some embodiments”, “illustrative embodiments”, “examples”, “specific examples”, or “some examples” means that the specific features, structures, materials, or characteristics described in conjunction with the embodiments or examples are included in at least one embodiment or example of the present application. In the specification, the illustrative expressions of the above terms may not necessarily refer to the same implementation or examples. Moreover, the specific features, structures, materials, or characteristics described can be combined in any one or more embodiments or examples in an appropriate manner.

In the description of the present specification, it should be noted that unless otherwise specified and limited, the terms “installation”, “provided with”, “sleeved/connected with”, “connection”, etc. should be broadly understood and, for example, “connection” can be a fixed connection, a detachable connection, or an integral connection; and can be a mechanical connection or an electrical connection; can be direct connection, indirect connection through an intermediate medium, or internal connection between two assemblies. The person having ordinary skill in the art can understand the specific meanings of the above terms in the present application in specific situations.

In the description of the present invention, relational terms such as “first” and “second”, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

The above description of the embodiments intends to help the person having ordinary skill in the art to understand and apply the technology of this case, and person skilled in the art can easily make various modifications to these embodiments and apply the general principles explained here to other embodiments without creative labor. Therefore, this case is not limited to the above embodiments, and modifications to the following should fall within the scope of protection of this case: \textcircled{1} new technical solutions based on the technical solution of the present invention and combined with existing common knowledge, which generate technical effects that do not exceed the technical effects of the present invention; \textcircled{2} equivalent substitution of some features of the technical solution of the present invention using well-known technology, which produces the same technical effect as the technical effect of the present invention; \textcircled{3} expansion based on the technical solution of the present invention, and the substantive content of the expanded technical solution does not exceed the scope of the technical solution of the present invention; \textcircled{4} equivalent transformations made using the content of the present invention specification and drawings, which are directly or indirectly applied to other related technical fields.

What is claimed is:

1. A linear motor comprising a stator slide rail and a rotor that slidably fits on the stator slide rail, further comprising:
a sealing module that is disposed on the rotor and slidably seals with the stator slide rail, and the rotor, stator slide rail, and sealing module together enclose a sealed space;
a ball return end cap that is disposed at both ends of the rotor, and each ball return end cap has a ball-returning channel, and the ball-returning channel and a first chute together form a circulating loop for ball movement;
a lubrication module that is disposed in the linear motor and connected to the sealed space;
a ball retaining plate comprising a locating surface that fits with the rotor, and contact surfaces that limit balls are provided on both sides of the locating surface.

2. The linear motor of claim 1, wherein the locating surface has a strip-shaped depression and/or strip-shaped protrusion along the sliding direction of the rotor, and the rotor has a fitting portion that is plug-in fitted with the strip-shaped depression and/or strip-shaped protrusion of the locating surface.

3. The linear motor of claim 1, wherein the rotor and the ball retaining plate together form the first chute having a contact gap, the contact gap is provided along the sliding direction of the rotor, the ball is controlled within the first chute, and each ball partially extends out from the contact gap to contact the stator slide rail.

4. The linear motor of claim 3, wherein the ball retaining plate is vertically symmetrical, and the contact gap is symmetrical along the plane of symmetry of the ball retaining plate.

5. The linear motor of claim 4, wherein the contact gap located on the upper side of locating surface faces diagonally upward; the contact gap located on the lower side of locating surface faces diagonally downwards.

6. The linear motor of claim 3, wherein the ball is close to the upper or lower half of one side of the stator slide rail and in contact with the stator slide rail.

7. The linear motor of claim 1, wherein the ball-returning channel has a first return port and a second return port, and the ball return end cap is provided with an oil passage connected to the outside, and the oil passage communicates with the ball-returning channel.

8. The linear motor of claim 1, wherein the ball-returning channel is provided with a groove structure that is inwardly recessed away from the ball-returning channel, and the groove structure is disposed along the direction of ball return path of the ball-returning channel.

9. The linear motor of claim 1, wherein the sealing module comprises a first sealing unit, and the rotor is connected to the first sealing unit that maintains sealing contact with the stator slide rail, the first sealing unit extends towards both ends along the sliding direction of the rotor and is in contact with both ends of the rotor, and the rotor, the first sealing unit, and the stator slide rail together form a sealed space.

10. The linear motor of claim 1, wherein the lubrication module comprises an oil box, an oil guide component, and a lubrication unit, and the linear motor is connected to the oil box having an oil storage chamber, and the oil storage chamber internally has an oil guide component, the oil guide component has a buffer surface and an oil guide end extending from the buffer surface towards the opposite side, and the oil guide component is connected to the lubrication unit that is used for linear motor lubrication.
